(19) United States
(12) Patent Application Publication
(10) Pub. No.: US 2005/0146654 A1
(43) Pub. Date: Jul. 7, 2005

(54) Liquid crystal display device

(76) Inventor: Shih-hsien Tseng, Hsin-chu (TW)

Correspondence Address: CROWELL & MORING LLP;INTELLECTUAL PROPERTY GROUP, P.O. BOX 14300, WASHINGTON, DC, 20044-4300, US

(21) Appl. No.: 11/029,464

(22) Filed: Jan. 6, 2005

(30) Foreign Application Priority Data
Jan. 7, 2004 (TW) 093100383

(51) Int. Cl. G02F 1/1335

(52) U.S. Cl. 349/69

(57) ABSTRACT

A liquid crystal display device (LCD), and particularly to a liquid crystal display which has reduced production cost and enhanced performance. The LCD comprises an optical module, a control module and a backlight module. The optical module is fabricated with known liquid crystal manufacturing process to provide at least a liquid crystal layer and a plurality of pixel unit electrodes, which are provided with a pixel electrode transparent area and a pixel electrode reflective area respectively. The control module is fabricated with known semiconductor manufacturing process. Further, using a plurality of conductive plugs disposed at preset positions, the backlight module is electrically connected to the pixel unit electrodes of optical module and the control circuit devices of the control module. The structure of the present invention resulting enhanced performance of the product, production yield and reliability, and reduced production cost.

### BACKGROUND OF THE PRESENT INVENTION

1. Field of the Invention

The present invention relates to a liquid crystal display device, and particularly to a liquid crystal display which can reduce the production cost and enhance product performance. Further, using a plurality of conductive plugs disposed at preset positions, the backlight module electrically connects the pixel unit electrodes to the optical module, which is made with known liquid crystal manufacturing process, and to the control circuit devices of control module which is made with known semiconductor manufacturing process.

2. Brief Description of the Related Art

The rapidly changing information industry, consumers' eager expectation of new products, and the ever changing product landscape in recent years, the manufacturers are investing a great deal of endeavors in product development. In the display area, the liquid crystal display (LCD) device holds great potential due to its, lightness, thinness, and low power consumption. Further, diversification of product also attracts eyes of the consumers.

The pixel unit structure of the conventional thin film transistor (TFT) liquid crystal display panel shown in FIG. 1 mainly includes a plurality of transverse gate lines 131 and a plurality of longitudinal data lines 133 to cross over each other and to form a plurality of pixel unit areas. A thin film transistor (TFT) 139 is provided at intersections of the data lines 133 and the gate lines 131 respectively. Each of the data line 133 extends to form a source electrode 134, each of the gate lines 131 extends to form a gate electrode 132 and the drain electrode 135 connects with the gate electrode 132 and the pixel electrode 137. The liquid crystal particles can be controlled to rotate by way of the thin film transistor 139 controlling potential of the pixel electrode 137 associated with an electrode disposed at another side of the liquid crystal layer (not shown) such that the image can be displayed.

There are two conventional types of liquid crystal display device, reflection type and transmission type. The pixel electrode 137 of reflection liquid crystal display device is made of material with excellent optical reflection property so that the image can appear by way of ambient reflection light. But, the displaying effect becomes inferior when the ambient light is weak. The pixel electrode 137 of the transmission type liquid crystal display device is made of transparent conductive material and the image can be shown by way of the transparent pixel unit electrode associated with the backlight light. The disadvantage of the transmission type liquid crystal display device is a great deal of power has to be consumed for producing the backlight. When the ambient light is stronger, the image display contrast of the backlight decreases and the display effect becomes undesirable.

Further, the thin film transistors 139 occupy part of the pixel area in the conventional pixel unit structure so that the display effect is degraded.

### SUMMARY OF THE INVENTION

An object of the present invention is to provide a liquid crystal display device, which has a backlight module disposed between the optical module and the control module to enhance the display effect in case of the ambient light being not sufficient.

Another object of the present invention is to provide a liquid crystal display device in which the conductive plugs formed in the backlight module connects with separately made optical module and control module to enhance the perfection rate and the reliability of the product.

A further object of the present invention is to provide a liquid crystal display device in which the control transistor of the pixel unit electrode can be independently made by way of matured semiconductor technique to increase the effective area of the pixel unit.

A further object of the present invention is to provide a liquid crystal display device in which the lower surface of pixel electrode reflective area on the pixel unit electrode has a cone shaped and the backlight projected over the pixel electrode reflective area can be dispersed to the pixel electrode transparent area for intensifying the quantity of the light.

A further object of the present invention is to provide a liquid crystal display in which the upper surface of the pixel electrode reflective area on the pixel unit electrode has a convex shape to expand the viewable angle.

A further object of the present invention is to provide a liquid crystal display in which a lens set can be provided to enhance display quality and magnify the image.

A further object of the present invention is to provide a liquid crystal display in which the optical module has an arc surface structure to enhance the integral quality of the formed image.

A further object of the present invention is to provide a liquid crystal display in which the conductive studs and the conductive connection terminals can be disposed between different control modules to offer diversified functions

### BRIEF DESCRIPTION OF THE DRAWINGS

The detail structure, the applied principle, the function and the effectiveness of the present invention can be more fully understood with reference to the following description and accompanying drawings, in which:

FIG. 1 is a plan view of pixel unit structure in the conventional TFT liquid crystal display panel;

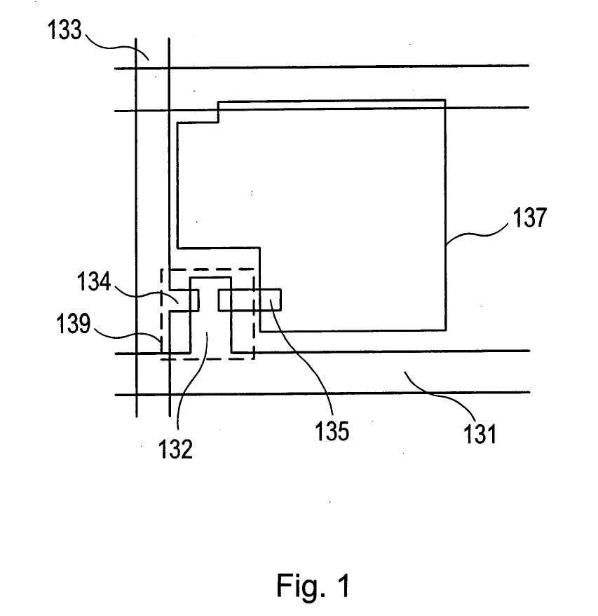

FIG. 2 is a partial sectional view of a preferred embodiment according to the present invention;

FIG. 3 is a sectional view of pixel unit layer shown in FIG. 2;

FIGS. 4A and 4B are partial sectional views illustrating different joining types between modules in the present invention;

FIGS. 5A and 5B are partial sectional views of pixel unit electrodes in different shapes;

FIG. 6 is a partial sectional view of another embodiment according to the present invention;

FIG. 7 is a partial sectional of a further embodiment according to the present invention;

FIGS. 8A and 8B are partial sectional views illustrating different joining ways for the modules shown in FIG. 7;

FIG. 9 is a partial sectional of a further embodiment according to the present invention; and

FIG. 10 a partial sectional of a further embodiment according to the present invention.

### DETAILED DESCRIPTION OF THE PREFERRED EMBODIMENTS

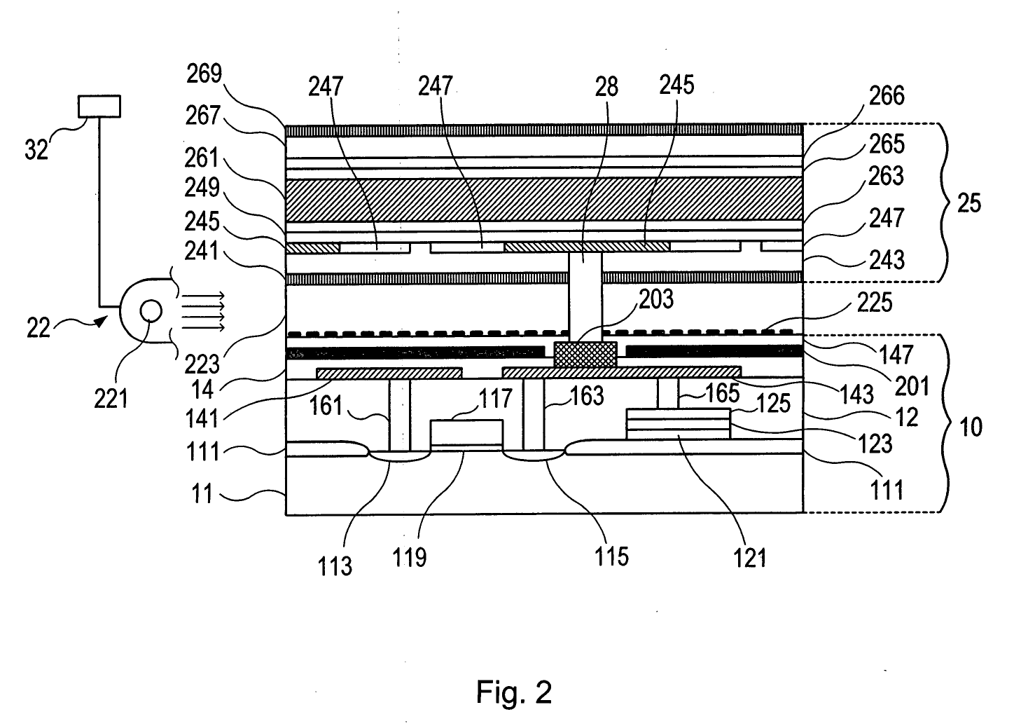

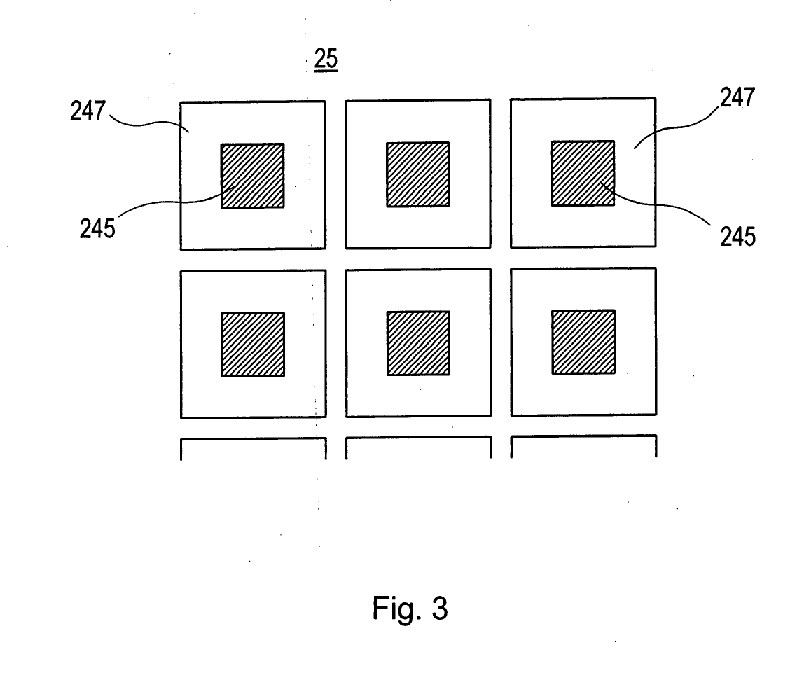

Firstly, referring to FIGS. 2, 3, 4A and 4B, a preferred embodiment is illustrated. The embodiment is a liquid crystal display device provided with transmission and reflection effects. The optical module 25 of the liquid crystal device according to the present invention has a first transparent substrate 243 with a plurality of pixel unit electrodes 256 formed thereon. Each pixel unit electrode 256 has a pixel electrode reflective area 245 and a pixel electrode transparent area 247. The pixel reflection area 245 can be made of metallic material or any other conductive material with excellent reflection capability and the pixel electrode transparent area 247 can be made of transparent conductive material such as Indium Tin Oxide (ITO). The pixel electrode reflection area 245 can be arranged at the center of each of the pixel unit electrodes 256 respectively and the pixel electrode transparent area 247 can be arranged to surround the pixel electrode reflection area 245 as shown in FIG. 3. Alternatively, the pixel electrode reflection area 245 and the pixel electrode transparent area 247 can be arranged in another ways such as, the pixel electrode transparent area 247 can be arranged at the center of each of the pixel unit electrodes 256 respectively and the pixel electrode reflection area 245 can be arranged to surround the pixel electrode transparent area 247 or being disposed pixel electrode transparent area 247 and pixel electrode reflection area 245 at a lateral side of the respective pixel unit electrode 256.

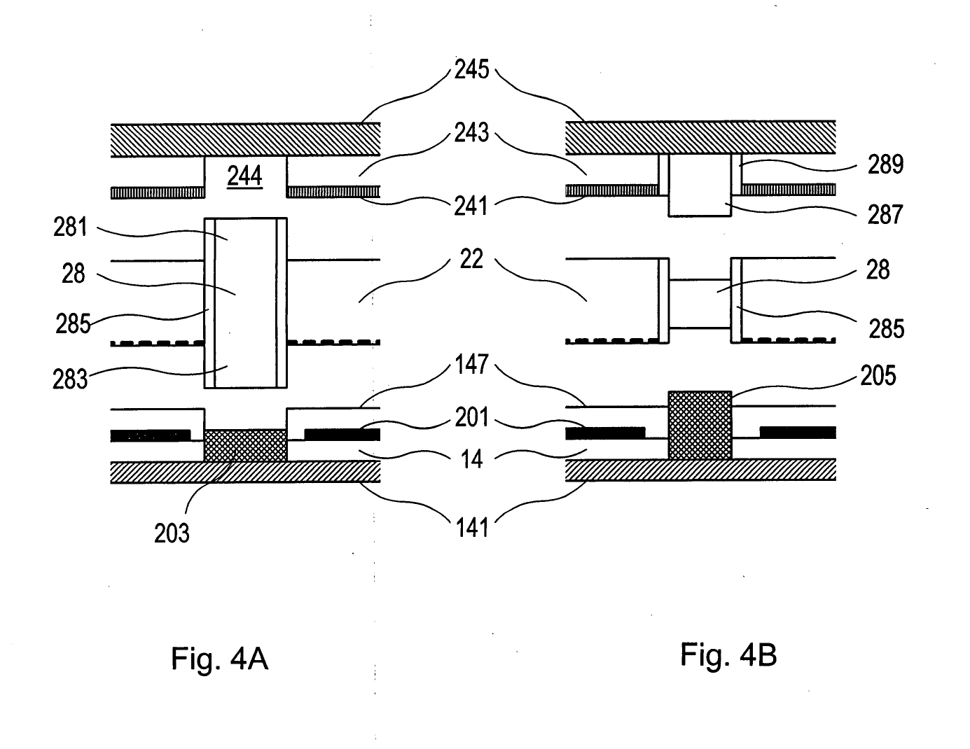

The respective pixel unit electrode 256 can be formed with a guard layer 249 for protection. The first transparent substrate 243 is provided with at least a hole (shown in FIG. 4A) by way of etching at the lower surface thereof corresponding to the respective pixel unit electrode 256 and a first alignment film 263 can be provided on the passivation layer 249.

The second transparent substrate 267 is provided with a transparent electrode 266 at the lower surface thereof and a second alignment film 265 is formed at the lower surface of the transparent electrode 266. A liquid crystal layer 261 is sandwiched between the first alignment film 263 of the first transparent substrate 243 and the second alignment film 265 of the second transparent substrate 267. Besides, the first transparent substrate 243 and the second transparent substrate 267 are provided at the upper surfaces thereof a first polarizer layer 241 and a second polarizer layer 269 respectively such that the light can be polarized thereof to comply with characteristics of the liquid crystal and generate effect of showing image.

A backlight module 22 can be embodied in multiple ways. For instance, FIG. 2 shows at least an illuminative member 221 is utilized to produce a backlight source and the light is sent to every part of the display device through a light guide layer 223. The lower surface of the light guide light layer 223 is treated to form a diffuse reflective surface 225 and the light can be distributed evenly upward to every part of the display device. The light guide layer 223 is provided with conductive material made conductive plugs 28 corresponding to the holes 244 of the optical module 25. In order to enhance conductive effect of the light, the conductive plugs 28 can be made of transparent conductive material such as TCO (the preceding ITO is a kind of transparent conducting oxide (TCO)), conductive high molecules and one of combined transparent conducing oxide (TCO) and conductive high molecules. Further, the backlight module 22 can provide a layer of organic electro-luminescent device (OLED) between the optical module 25 and the control module 10 and the OLED can emit light upward directly to offer backlight source. A conductive plug 28 is mounted at each of the holes 244 as medium for connecting with the control module 10 and pixel unit electrode 256. Each of the conductive plugs 28 in the preceding embodiment can provide an insulating layer 285 at the edge of a lateral side thereof to offer protection for the conductive plugs 28 and other peripheral components of the conductive plugs 28 in addition to secure function of the circuit. Each of the substrate can be made of flexible material to provide the flexibility of display panel.

The control module 10 is fabricated by way of conventional manufacturing process for semiconductor to integrate the circuits and device components into at least a chip. First of all, device components of control circuit such as transistors and capacitors are fabricated with semiconductor manufacturing process steps on a semiconductor substrate 11. The transistor includes a drain electrode 113 and a source electrode 115 and a gate electrode 117 is provided on a gate dielectric layer 119. An isolation layer 111 is disposed between circuit device components as a partition. The capacitor component is provided with a bottom electrode 121, a dielectric layer 123 a top electrode 125 sequentially on the isolation layer 111. Once the circuit components have been manufactured on the semiconductor substrate 11, an insulating layer 12 is formed on the substrate to protect the components in addition to providing insulation and isolation.

After forming the insulating layer 12, the contacts are formed at the position of the drain electrode 113, the source electrode 115 and the top electrode 125 by etching process and the contacts are filled with conductive material such as titanium, titanium nitride, tungsten and aluminum to connect with the drain electrode 113, the source electrode 115 and the top electrode 125 respectively to form conductive contacts (via) 161, 163 and 165. The surface of the insulating layer 12 has a conductive circuit layout formed with metal. The metal line 141 connects with the drain electrode 113 through the conductive contact 161 and the metal line 143 connects with the source electrode 115 and the top electrode 125 through the conductive contacts 163 and 165.

The surface of the insulating layer 12 provides preset positions for the conductive circuit layout and each of the preset positions has a conductive connection terminal 203 respectively and forms an insulating layer 14 covering each metal line. A reflective layer 201 is formed on the insulating layer 14, and another silicon dioxide insulating layer 147 covering the reflective layer thereon. The reflecting layer 201 can enhance reflection effect of the diffuse reflective surface 225 in the light guide layer 223.

After each of the modules having been fabricated completely, the modules are combined and the arrangement can be the configuration as shown in FIGS. 4A and 4B. It can be seen that the backlight module 22 has the conductive plugs 28 extending upward and downward beyond the upper and lower surfaces thereof to form top studs 281 and bottom studs 283. The top studs 281 are inserted into the holes 244 of the first transparent substrate 243 to connect pixel unit electrode 256 during assembling. The bottom studs 283 connect with conductive connection terminals 203 of the control module 10 or connect with the preset positions of the conductive circuit layout in the control module 10. In this way, the pixel unit electrode 256 is electrically connected to the control circuit of the control module 10 as shown in FIG. 4A.

Further, a conductive stud 287 made of conductive material can be provided in the hole 244 of the first transparent substrate 243 with an insulating layer 289 between the conductive stud 287 and the first transparent substrate 243. The conductive connection terminal 205 of the control module 10 can extend outward from the upper surface of the control module 10, by way of the conductive stud 287 and the conductive connection terminal 205 electrically connecting with the conductive plug 28 of the backlight module 22 such that the control circuit of control module 10 and the pixel unit electrode 256 can be electrically connected. Furthermore, the conductive plug 28 of the backlight module can be ignored by extending the conductive stud 287 and the conductive connection terminal 205, such that the control circuit of control module 10 and the pixel unit electrode 256 can be electrically connected.

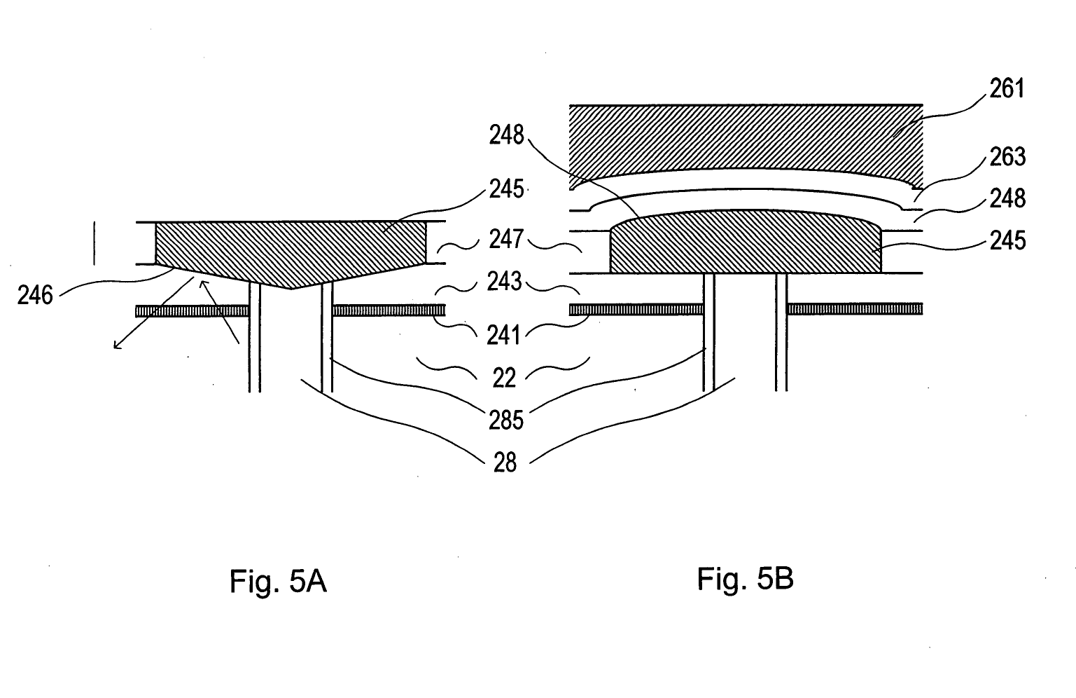

Referring to FIGS. 5A and 5B, it can be seen from the partial sectional views of different arrangements for the pixel unit electrodes that the pixel electrode reflective area 245 of the pixel unit electrode can improve the display effect by way of the minor design change. The lower surface 246 of the pixel electrode reflective area 245 can be made to have a cone shaped outward surface so that the light from the backlight module illuminating the lower surface 246 of the pixel electrode reflective area 245 can be reflected to other areas and finally penetrates the pixel electrode transparent area 247 as shown in FIG. 5A so as to reduce energy loss and enhance the luminance of the backlight.

The upper surface 248 of the pixel electrode reflective area 245 can be made as a convex surface, which provides function of diffusion such that it is possible to make up the deficiency of the pixel electrode transparent area having insufficient luminance during creating image in case of the ambient light being stronger and it is capable of eliminating the visional space between pixel units in the conventional liquid crystal display. Furthermore, partial convex design of the pixel unit electrode 256 can result in a minor pretilt angle during part of the liquid crystal molecules being arranged to increase visual range of the display device.

The pixel electrode transparent area 247 and the pixel electrode reflective area 245 of the pixel unit electrode 256 can be coated with different optical films on the surfaces thereof to adjust different optical path required for transmission display and reflection display, or the pixel electrode transparent area 247 and the pixel electrode reflective area 245 can be provided with a thickness different from each other to achieve adjustment of optical path during manufacturing the passivation layer.

In addition, a light sensor 32 can be mounted in the preceding embodiment to connect the backlight module 22 and the control module 10 respectively to turn on the backlight, turn off the backlight and adjust the intensity of backlight based on sensed ambient luminance so as to maintain optimum display quality and save power consumption.

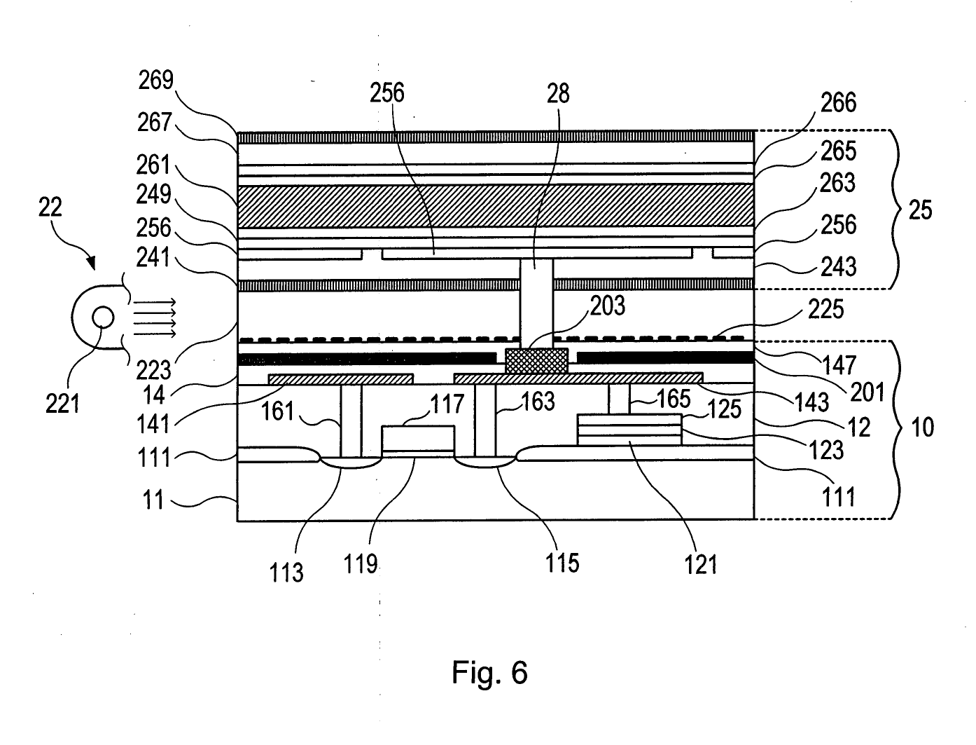

Referring to FIG. 6, another embodiment is illustrated. The structure of the present embodiment is similar to that shown in FIG. 2 and the difference of the present embodiment from the first embodiment is to use a transmission type liquid crystal display device. Hence, the control module 10 and the backlight module 22 of the present embodiment are not different from those in the first embodiment. The pixel unit electrode 256 in the optical module 25 is made of transparent conductive material such as ITO.

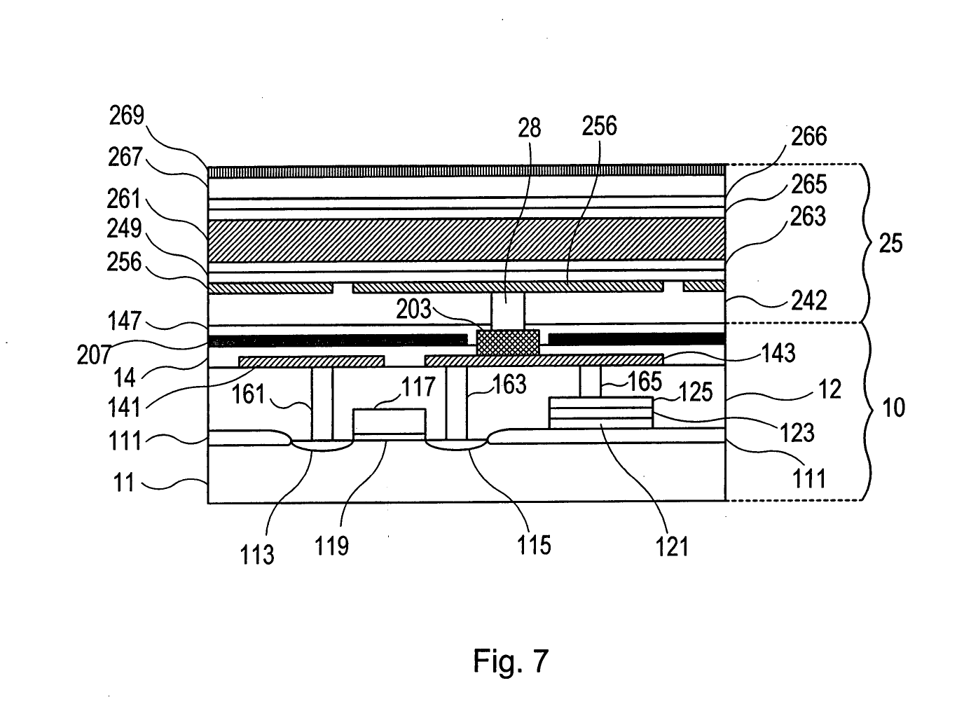

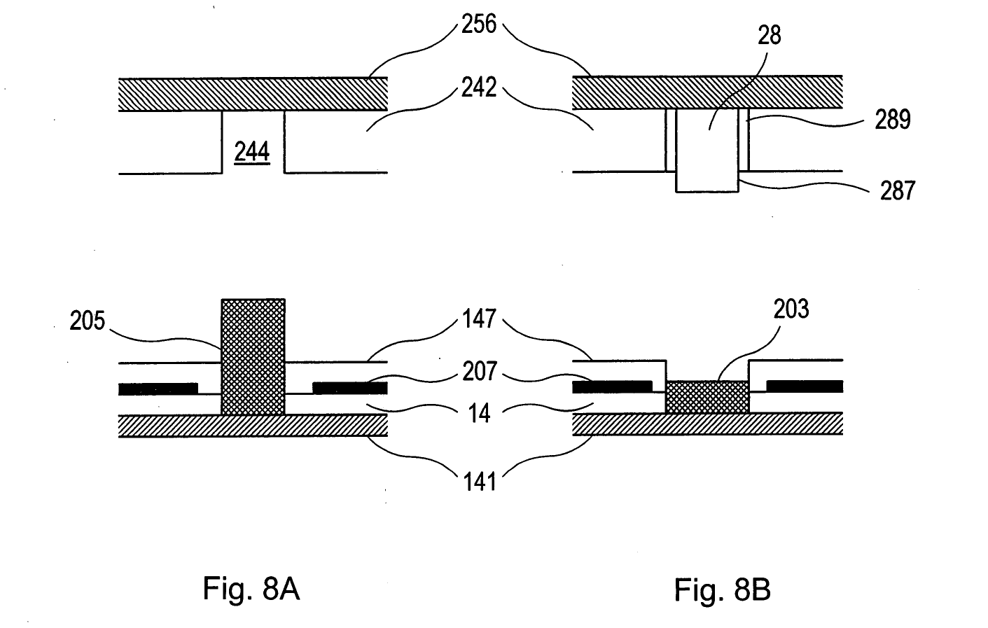

Referring to FIGS. 7, 8A and 8B, a further embodiment is illustrated. The present embodiment is to apply the art disclosed in the present invention to a reflection type liquid crystal display device. The present embodiment basically includes an optical module 25 and a control module 10 and both the modules are almost the same as those shown in FIG. 2.

The pixel unit electrode 256 of the optical module 25 and a light mask layer 207 of the control module 10 can be matched and changed to different shapes. In case of the pixel unit electrode 256 being made of conductive material with excellent reflection capability such as metallic material, the substrate 242 can be made of opaque material and the light mask layer 207 can be made of excellent light absorption material to block or absorb diffusion light so as to prevent the diffusion light from interfering the circuit components. When the pixel unit electrode 256 is made of transparent conductive material such as ITO, the transparent material should be chosen for the substrate 242 and material with excellent reflection capability should be chosen for the light mask layer 207 so as to enhance the effect of light reflection.

Referring to FIGS. 8A and 8B, assembly of the control module 10 and the optical module 25 is illustrated. Each of the conductive connection terminals 205 extends outward from the upper surface of the control module 10 to insert into corresponding holes 244 in the substrate 242 for connecting with the pixel unit electrode 256 as shown in FIG. 8A. Besides, a conductive plug 28 made of conductive material is inserted into each of the holes 244 and a lateral side of the conductive plug 28 can provide an insulating layer 289 at the edge thereof. An end of the conductive plug 28 extends downward from the lower surface of the substrate 242 to form a conductive stud 287 and the pixel unit electrode 256 can be electrically connected with the control circuit by way of the conductive studs 287 electrically connecting with the conductive connection terminal 203 of the control module 10.

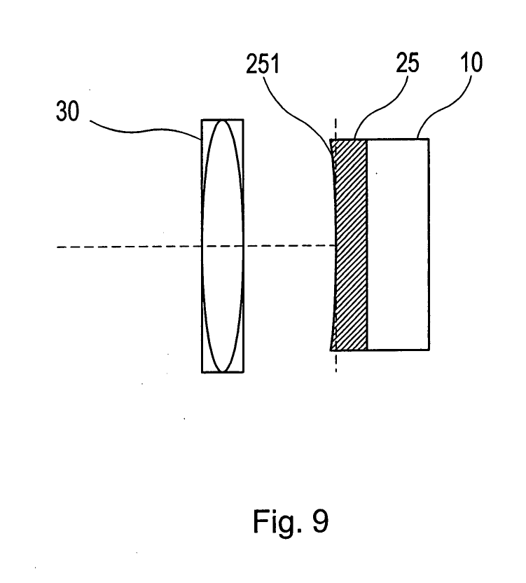

Referring to FIG. 9, a further embodiment of the present invention is illustrated. It can be seen that the liquid crystal display device of the present invention can add a lens module 30 to the optical module 25. The liquid crystal display device is driven and controlled with the control module 10 and the image can be displayed with the optical module 25. The quality of the display image can be improved or magnified with the lens module 30 to enhance the capability of the display device. Further, the upper surface 251 of the optical module 25 can be made as an arc surface to present more perfect image display therein matching with the lens module 30.

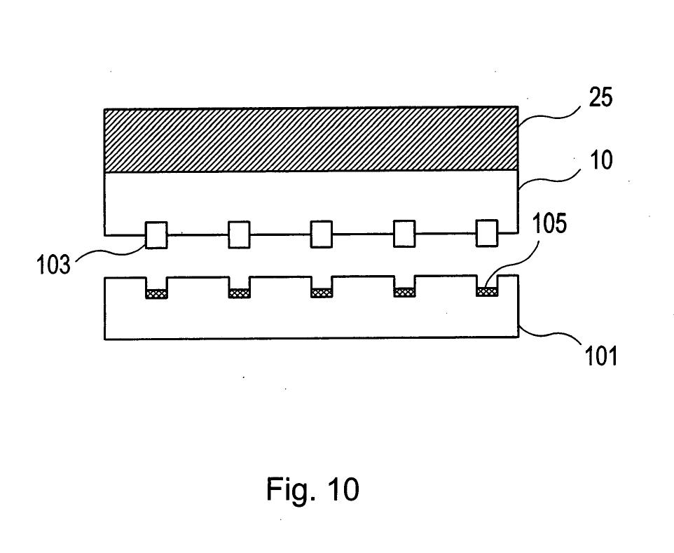

Finally, referring to FIG. 10, a further embodiment of the present invention illustrated and it can be seen from the sectional view in the figure that the embodiment can further include at least a second control module 101 fabricated by way of manufacturing process for semiconductor. The control modules 10 can form a plurality of conductive studs 103 at the lower surfaces thereof with the same principle and the second control module 101 has a conductive connection terminals 105 thereof corresponding to the conductive studs 103. By using the conductive studs 103 being electrically connected to the conductive connection terminals 105, the control modules in different function features can be associated with each other such that the liquid crystal display device can provide more powerful and diversified functions.

Due to the technique of manufacturing process for semiconductor and technique for making a liquid crystal display panel being very mature, the technique provided in the present invention makes the optical module, the backlight module and the control module possible to be fabricated independently before being joined together with innovative structure design involving in utilization of the existing art. Hence, the present invention can not only increase the production yield but also simplify the manufacturing process and reduce the cost.

It is appreciated that the liquid crystal display device has at the backlight module thereof a plurality of preset positions being provided with a conductive plug respectively to connect the optical module made by way of matured liquid crystal manufacturing process and to connect the control module made by way of matured semiconductor manufacturing process so as to increase the production yield and lower production cost.

While the invention has been described with referencing to the preferred embodiments thereof, it is to be understood that modifications or variations may be easily made without departing from the spirit of this invention, which is defined by the appended claims.

1. A liquid crystal display device, comprising:
an optical module, further comprising at least a liquid crystal layer and a plurality of pixel unit electrodes, each of the pixel unit electrodes providing a pixel electrode transparent area and a pixel electrode reflective area for displaying a image;
a control module, further comprising a plurality of control circuit components; and
a backlight module, being disposed between the optical module and control module, therein the backlight module for offering a light source and enhancing effect of display in case of weak ambient light;
wherein, the backlight module has a plurality of conductive plugs being provided at a plurality of preset positions to electrically connect the control module and the pixel unit electrodes.

2. The liquid crystal display device according to claim 1, wherein the backlight module comprises:
at least a luminous component, supplying light source of the backlight module; and
a light guide layer, being made of transparent material to transmit the light generated from the luminous component, providing a lower surface being treated as a diffusion surface for the light evenly diffusing upward and the preset positions being disposed therein with one of the conductive plugs respectively.

3. The liquid crystal display device according to claim 1, wherein the backlight module is an organic light emitting device and the conductive plugs are disposed in the preset positions of the organic light emitting device.

4. The liquid crystal display device according to claim 1, wherein the optical module further comprises:
a first transparent substrate, having an upper surface formed with the pixel unit electrodes and each of the pixel unit electrodes providing a pixel electrode transparent area and a pixel electrode reflective area; and
a second transparent substrate, having a lower surface with a transparent electrode, and
the liquid crystal layer being sandwiched between the first transparent substrate and the second transparent substrate;
wherein, the first transparent substrate provides at the positions of the pixel unit electrodes a least a hole and the pixel unit electrodes is electrically connected to the control module through the hole.

5. The liquid crystal display device according to claim 4, wherein the pixel electrode reflective area on each of the pixel unit electrodes is made of transparent conductive material.

6. The liquid crystal display device according to claim 4, wherein the pixel electrode reflective area on each of the pixel unit electrodes is made of metallic material.

7. The liquid crystal display device according to claim 4, wherein one of the pixel electrode transparent area, the pixel electrode reflective area and combination of the pixel electrode transparent area and the pixel electrode reflective area is coated with optical films so as to adjust the optical path difference between the pixel electrode transparent area and the pixel electrode reflective area.

8. The liquid crystal display device according to claim 4, wherein the conductive plugs in the backlight module extends outward from the upper surface of the backlight module and form top studs to electrically connect with corresponding pixel unit electrodes through the holes in the first transparent substrate.

9. The liquid crystal display device according to claim 4, wherein the holes of the first transparent substrate can be provided with a conductive studs respectively extending outward from the lower surface of the first transparent substrate to electrically connect with the pixel unit electrodes and corresponding conductive plugs.

10. The liquid crystal display device according to claim 4, wherein the first and second substrates are flexible substrate.

11. The liquid crystal display device according to claim 1, wherein all of the control circuit devices in the control module are integrated into at least a chip by using of semiconductor manufacturing process and a facial side of the chip has a plurality of conductive connection terminals corresponding to the conductive plugs of the backlight module so that the conductive plugs are electrically connected to the conductive connection terminals.

12. The liquid crystal display device according to claim 1, wherein a lens module is formed to the optical module.

13. The liquid crystal display device according to claim 1, wherein a light sensor can be provided to connect with the backlight module and the control module to turn on or turn off the backlight to adjust the backlight illumination based on the ambient luminance.

14. The liquid crystal display device according to claim 1, wherein the optical module, the backlight module and the control module are made independently before being assembled.

15. The liquid crystal display device according to claim 11, further comprises at least a second control module fabricated by way of the semiconductor manufacturing process thereof providing a plurality of conductive connection terminals and the control module, which is opposite to the side connecting the backlight module, provides a plurality of conductive studs to electrically connect with the conductive connection terminals of the second control module.

16. A liquid crystal display device, comprising:
an optical module, further comprising at least a liquid crystal layer and a plurality of transparent pixel unit electrodes for displaying an image;
a control module, further comprising a plurality of control circuit device; and
a backlight module, being disposed between the optical module and the backlight module to offer a light source required for image display;
wherein the backlight module has a plurality of conductive plugs provided at a plurality of preset positions corresponding to the conductive plugs for electrically connecting with the control module and the transparent pixel unit electrodes.

17. The liquid crystal display device according to claim 16, wherein the backlight module comprises:
at least an illuminative component, supplying light source of the backlight module; and
a light guide, being made of transparent material to transmit the light generated from the illuminative component, providing a lower surface being treated as a diffuse reflective surface for the light evenly diffusing upward and the preset positions being disposed therein with one of the conductive plugs respectively.

18. The liquid crystal display device according to claim 16, wherein the backlight module is an organic light emitting device and the conductive plugs are disposed in the preset positions of the organic light emitting device.

19. The liquid crystal display device according to claim 16, wherein the optical module further comprises:
a first transparent substrate, having an upper surface formed with the transparent pixel unit electrodes and each of the pixel unit electrodes providing a pixel electrode transparent area; and
a second transparent substrate, having a lower surface with a transparent electrode and the liquid crystal layer being sandwiched between the first transparent substrate and the second transparent substrate;
wherein, the first transparent substrate provides at the positions of the pixel unit electrodes a least a hole and the control module electrically connects with the pixel unit electrodes through the hole.

20. The liquid crystal display device according to claim 19, wherein the first and second substrates are flexible substrates.

21. The liquid crystal display device according to claim 16, wherein all of the control circuit devices in the control module are integrated into at least a chip by semiconductor manufacturing process and a facial side of the chip has a plurality of conductive connection terminals corresponding to the conductive plugs of the backlight module so that the conductive plugs are electrically connected to the conductive connection terminals.

22. The liquid crystal display device according to claim 16, wherein a lens module can be added above the optical module.

23. The liquid crystal display device according to claim 16, wherein the optical module, the backlight module and the control module can be made independently before being assembled.

24. The liquid crystal display device according to claim 21, further comprises at least a second control module fabricated with the semiconductor manufacturing process thereof providing a plurality of conductive connection terminals on one side and the second side of the control module, which is opposite to the side connecting the backlight module, provides a plurality of conductive studs to connect with the conductive connection terminals of the second control module.

25. A liquid crystal display device, comprising:
a substrate;
a plurality of pixel unit electrodes, being formed on the upper surface of the substrate;
a transparent substrate, providing a transparent electrode at a lower surface thereof;
a liquid crystal layer, being sandwiched between the substrate and the transparent substrate; and
a control module, providing a plurality of control circuit devices;
wherein the substrate is provided with at least a hole at each of the pixel unit electrodes so that the control module can electrically connect with the pixel unit electrodes through the hole respectively.

26. The liquid crystal display device according to claim 25, wherein all the control circuit devices in the control module are integrated into at least a chip by semiconductor manufacturing process and has a plurality of conductive connection terminals corresponding to the conductive plugs of the substrate so that it is possible for the conductive plugs connecting with the conductive connection terminals.

27. The liquid crystal display device according to claim 26, wherein the holes of the substrate can be provided with a conductive plug respectively to extend outward the lower surface of the substrate for connecting with the corresponding conductive connection terminals on the control module.

28. The liquid crystal display device according to claim 27, wherein the conductive plugs are made of metallic material.

29. The liquid crystal display device according to claim 25, wherein the pixel unit electrodes are made of metallic material.

30. The liquid crystal display device according to claim 25, wherein a lens module is added above the transparent substrate.

31. The liquid crystal display device according to claim 25, wherein the first and second substrates are flexible substrates.

32. The liquid crystal display device according to claim 25, wherein the control module can be fabricated separately from other components before being assembled.

33. The liquid crystal display device according to claim 26, further comprises at least a second control module fabricated with the semiconductor manufacturing process thereof providing a plurality of conductive connection terminals on one side and the second side of the first control module, which is opposite to the side connecting to the pixel unit electrodes substrate, provides a plurality of conductive studs to connect with the conductive connection terminals of the second control module.
